(19) United States
(12) Patent Application Publication
(10) Pub. No.: US 2012/0016926 A1
(43) Pub. Date: Jan. 19, 2012

(54) SCALABLE TECHNIQUES FOR PROVIDING REAL-TIME PER-AVATAR STREAMING DATA IN VIRTUAL REALITY SYSTEMS THAT EMPLOY PER-AVATAR RENDERED ENVIRONMENTS

(75) Inventors: James Toga, Wayland, MA (US); Siddhartha Gupta, Marlboro, MA (US); Kenneth Cox, Marlboro, MA (US); Rafal K. Boni, Needham, MA (US)

(73) Assignee: VIVOX INC., Natick, MA (US)

(21) Appl. No.: 12/863,118

(22) Filed: Jul. 15, 2010

(51) Int. Cl. G06F 15/16

(52) U.S. Cl. 709/203

(57) ABSTRACT

Scalable techniques for rendering emissions represented using segments of streaming data, the emissions being potentially perceivable from many points of perception and the emissions and the points of perception having relationships that vary in real time. The techniques filter the segments by determining for a time slice whether a given emission is perceptible to a given point of perception. If it is not, the segments of streaming data representing the emission are not used to render the emissions as perceived from the given point of perception. The techniques are used in networked virtual environments to render audio emissions at clients in a networked virtual reality system. With audio emissions, one determinant of whether a given emission is perceivable at a given point of perception is whether psychoacoustic properties of other emissions mask the given emission. The segments representing the streaming data also contain metadata which is used both in the filtering and in rendering the streaming data for a point of perception at which the emission is perceived.

### CROSS-REFERENCE TO RELATED APPLICATIONS

The subject matter of this patent application is related to and claims priority from PCT Application No. PCT/US2009/031361, which is related to and claims priority from the following U.S. provisional patent application, which is hereby incorporated by reference in its entirety: U.S. Provisional Patent Application 61/021,729, Rafal Boni, et al, Relevance routing system, filed Jan. 17, 2008.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The techniques disclosed herein relate to virtual reality systems and more particularly to the rendering of streaming data in multi-avatar virtual environments.

2. Description of Related Art

### Virtual Environments

The term virtual environment—abbreviated as VE—refers in this context to an environment created by a computer system that behaves in ways that follow a user of the computer system's expectations for a real-world environment. The computer system that produces the virtual environment is termed in the following a virtual reality system and creation of the virtual environment by the virtual reality system is termed rendering the virtual environment. A virtual environment may include an avatar, in this context an entity belonging to the virtual environment that has a point of perception in the virtual environment. The virtual reality system may render the virtual environment for the avatar as perceived from the avatar's point of perception. A user of a virtual environment system may be associated with a particular avatar in the virtual environment. An overview of the history and development of virtual environments can be found in “Generation 3D: Living in Virtual Worlds”, IEEE Computer, October 2007.

In many virtual environments, a user who is associated with an avatar can interact with the virtual environment via the avatar: the user can not only perceive the virtual environment from the avatar's point of perception, but can also change the avatar's point of perception in the virtual environment and otherwise change the relationship between the avatar and the virtual environment or change the virtual environment itself. Such virtual environments are termed in the following interactive virtual environments. With the advent of high-performance personal computers and high-speed networking, virtual environments—and in particular multi-avatar interactive virtual environments in which avatars for many users are interacting with the virtual environment at the same time—have moved from engineering laboratories and specialized application areas into widespread use. Examples of such multi-avatar virtual environments include environments with substantial graphical and visual content like those of massively-multiplayer on-line games—MMOGs, such as World of Warcraft®—and user-defined virtual environment environments—such as Second Life®. In such systems, each user of the virtual environment is represented by an avatar of the virtual environment, and each avatar has a point of perception in the virtual environment based on the avatar's virtual location and other aspects in the virtual environment. Users of the virtual environment control their avatars and interact within the virtual environment via client computers such as PC or workstation computers. The virtual environment is further implemented using server computers. Renderings for a user's avatar are produced on a user's client computer according to data sent from the server computers. Data is transmitted between the client computers and server computers of the virtual reality system over the network in data packets.

Most of these systems present a visual image of the virtual environment to a user's avatar. Some virtual environments present further information to the user, such as sound heard by the user's avatar in the virtual environment, or output for from the avatar's virtual sense of touch. Virtual environments and systems have also been devised that consist primarily or solely of audible output to users, such as that produced by the LISTEN system developed at the Fraunhofer Institute, as described in “Neuentwicklungen auf dem Gebiet der Audio Virtual Reality”, Fraunhofer-Institut fuer Medienkommunikation, Germany, July 2003.

If the virtual environment is interactive, the appearance and actions of the avatar for a user are what other avatars in the virtual environment perceive—see or hear, etc.—as representing the user's appearance and action. Of course, there is no requirement for the avatar to appear or be perceived as resembling any particular entity, and an avatar for a user may intentionally appear quite different from the user's actual appearance—this is one of the appealing aspects to many users of interaction in a virtual environment in comparison to interactions in the “real world”.

Because each avatar in a virtual environment has an individual point of perception, the virtual reality system must render the virtual environment differently for different avatars in a multi-avatar virtual environment. What a first avatar perceives—e.g. “sees”, etc.—will be from one point of perception, and what a second avatar perceives will be different. For example, the avatar “Ivan” might “see” avatars “Sue” and “David” and a virtual table from a particular location and virtual direction, but not see the avatar “Lisa” as that avatar is “behind” Ivan in the virtual environment and thus “out of view”. A different avatar “Sue” might, at the same time, see the avatars Ivan, Sue, Lisa and David and two chairs from a completely different angle. Another avatar “Maurice” might be at that moment in a completely different virtual location in the virtual environment, and not see any of the avatars Ivan, Sue, Lisa or David (nor do they see Maurice), but instead Maurice sees other avatars that are near the same virtual location as Maurice. In the present discussion, renderings that differ for different avatars are termed per-avatar renderings.

FIG. 2 shows an example of a per-avatar rendering for a particular avatar in an example virtual environment. FIG. 2 is a static image from the rendering—in actuality the virtual environment would render the scene dynamically and in color. The point of perception in this example of rendering is that of the avatar for which the virtual reality system is making the rendering shown in FIG. 2. In this example, a group of avatars for eight users have “gone” to a particular locale in the virtual environment—the locale contains two tiered platforms at 221 and 223. In this example, the users—who may be in real-world locations very far apart—have arranged to “meet” (via their avatars) in the virtual environment for a conference to discuss something, and thus their avatars represent their presence in the virtual environment.

Seven of the eight avatars—in this example all the avatars shown are human-like figures—are visible: the avatar for which the virtual reality system is making the rendering is not visible, as the rendering is made from the point of perception of that avatar. For convenience, the avatar for which the rendering is made is referred to in FIG. 2 as 299. The figure contains an unattached label 299 with a brace encompassing the entire image to indicate that the rendering was made from the point of the avatar indicated by “299”.

Four avatars are visible standing on platform 221, including avatars labeled 201, 209 and 213. The three remaining avatars are visible standing between the two platforms, including the avatar labeled 205.

As is visible in FIG. 2, the avatar 209 is standing behind the back of avatar 213. In a rendering of this scene for the point of perception for avatar 213, neither of the avatars 209 or 299 would be visible, as they would be “out of view” for avatar 213.

The example in FIG. 2 is for a virtual reality system in which users may interact via their avatars, but the avatars cannot emit speech. Instead in this virtual reality system, users make their avatars “speak” by typing text on keyboards: the virtual environment renders the text in a “text balloon” above the avatar for the user: optionally, a bubble with the name of the user's avatar is rendered the same way. One example for the avatar 201 is shown at 203.

In this particular exemplary virtual reality system, users can cause their avatars to move or walk from one virtual location to another, or to turn to face a different direction, by using the arrow keys on a keyboard. There are also keyboard inputs to make the avatar gesture by moving the hands and arms. Two examples of this gesturing are visible: avatar 205 is gesturing, as can be seen from the raised hands and arms circled at 207, and avatar 209 is gesturing as shown by the position of the hands and arms in circled at 211.

Users can thus move, gesture, and converse with each other via their avatars. Users can, via their avatars, move to other virtual locations and places, meet with other users, hold meetings, make friends, and engage in many aspects of a “virtual life” within the virtual environment.

### Problems in Implementing Large Multi-Avatar Rendered Environments

There are several problems in implementing large multi-avatar rendered environments. Among them are:
The sheer number of different, individual renderings the virtual environment must create for the many avatars.
The necessity of providing a networked implementation with many connections, with delays and limits on the data bandwidths available.

As the fact that the virtual reality system of FIG. 2 uses text balloons to deal with speech shows, live sound poses difficulties for present-day virtual reality systems. One reason why live sound poses difficulties is that it is an example of what will be termed in the following an emission, that is, an output in the virtual environment which is produced by an entity in the virtual environment and which is perceivable to avatars in the virtual environment. An example of such an emission is speech produced by one avatar in the virtual environment that is audible to other avatars in the virtual environment. A characteristic of emissions is that they are represented in the virtual reality system by streaming data. Streaming data in the present context is any data that has high data rates and changes unpredictably in real time. Because streaming data is constantly changing, it must be sent all the time, in a continual stream. In the context of a virtual environment, there may be many sources emitting streaming data at once. Further, the virtual location for the emission and the points of perception for possibly-perceiving avatars may change in real time.

Examples of kinds of emissions in a virtual environment include audible emissions that can be heard, visible emissions that can be seen, haptic emissions that can be felt by touch, olfactory emissions that can be smelled, taste emissions that can be tasted, and emissions peculiar to the virtual environment, such as virtual telepathic or force-field emissions. A property of most emissions is intensity. The kind of intensity will of course depend on the kind of emission. With emissions of sound, for example, intensity is expressed as loudness. Examples of streaming data are data representing sound (audio data), data representing moving images (video data), and also data representing continuous force or touch. New kinds of streaming data are constantly being developed. Emissions in a virtual environment may come from real-world sources, such as speech from the user associated with an avatar, or from generated or recorded sources.

The source of an emission in a virtual environment can be any entity of the virtual environment. Taking sound as an example, examples of audible emissions in a virtual environment include sounds made by entities in the virtual environment—e.g. an avatar emitting what the avatar's user speaks into a microphone, a generated gurgling sound emitted by a virtual waterfall, a blast sound emitted a virtual bomb, a clicky-clack sound emitted by virtual high-heels on a virtual floor—and background sounds—e.g. a background sound of a virtual breeze or wind emitted by a region of virtual environment, or background sound emitted by a virtual herd of chewing animals.

The sounds in a sequence of sounds, the relative locations of the emitting sources and avatars, the quality of the sounds emitted by the sources, the audibility and apparent loudness of the sounds to an avatar, and the orientation of each potentially-perceiving avatar, may in fact all change in real time. The same is the case with other kinds of emissions and kinds of streaming data.

The problems of rendering emissions as perceived by each avatar individually in a virtual environment are complex. These problems are much aggravated when sources and destination avatars move in the virtual environment while the sources are emitting: for example, when a user speaks through her or his avatar while also moving the emitting avatar, or also when other users move their avatars while perceiving the emission. This latter aspect—the perceiving avatar moving in the virtual environment—affects even emissions from stationary sources in the virtual environment Not only does the streaming data representing the emission change continually, but also how it is to be rendered and the perceiving avatars for which it is to be rendered. The renderings and the perceiving avatars change not only as the potentially-perceiving avatars move in the virtual environment, but also as the sources of the emissions move in the virtual environment.

At a first level of this complexity, whether a potentially-perceiving avatar can actually perceive the sequence of sounds emitted by a source at a given moment depends at least on the volume of the sounds emitted by the source at each moment. Further, it depends on the distance in the virtual reality between the source and the potentially-perceiving avatar at each moment. As in the “real world”, sounds that are “too soft” relative to a point of perception in the virtual environment will not be audible to an avatar at that point of perception. Sounds that come from “far away” are heard or perceived as softer than when they come from a lesser distance. The degree to which the sound is heard as softer with distance is termed a distance-weight factor in this context. The intensity of a sound at the source is termed the intrinsic loudness of the sound. The intensity of a sound at the point of perception is termed the apparent loudness.

At a second level, whether an emitted sound is audible to a particular avatar may also be determined by other aspects of the particular avatar's location relative to the source, the sounds the perceiving avatar is hearing concurrently from other sources, or by the quality of the sounds. For example, the principles of psychoacoustics include the fact that louder sounds in the real world can mask, or make inaudible, sounds that are less loud (based on apparent loudness for the individual listener). This is referred to as the relative loudness or volume of the sounds, where the apparent loudness of one sound is greater in relation to the apparent loudness of another sound. Further psychoacoustic effects include that sounds of some qualities tend to be heard over other sounds: for example, humans may be especially good at noticing or hearing the sound of a baby crying, even when the sound is soft and there are other louder sounds at the same time.

As a further complexity, it may be desirable to render sounds such that they are rendered directionally for every avatar for which the sounds are audible—so that every sound for every avatar is perceived as coming from the appropriate relative direction for that avatar. Directionality thus depends not only on the virtual location of the avatar for which the sounds are audible, but also on the location of every source of potentially audible sound in the virtual environment, and further on the orientation of the avatar is “facing” in the virtual environment.

A virtual reality system of the existing art that might perform acceptably for rendering emissions to and from a small handful of sources and avatars may simply be unable to cope with the tens of thousands of sources and avatars in a large multi-avatar rendered environment. In common words, such a system is not scalable to deal with large numbers of sources and avatars.

To summarize, per-avatar rendering of emissions from multiple sources in a virtual environment, such as audible emissions from multiple sources, presents special problems, in that the streaming data representing the emissions from each source:
is emitted and changes pretty much continually
has correspondingly high data rates
must be rendered from many separate sources at once
must be rendered for each listening avatar individually at once
is complex or expensive to render
is difficult to handle when there are many sources and avatars.

### Current Techniques for Handling Streaming Data in Multi-Avatar Rendered Environments

Current techniques for rendering streaming data in a virtual environment give limited success in dealing with the problems mentioned. As a result, implementers of multi-avatar virtual environments are forced to make one or more unsatisfactory compromises:
No support for emissions that must be represented using streaming data, such as audible or visible emissions.
   A virtual environment may support only “text chat” or “instant messages” in a broadcast or point-to-point fashion, and not have audio interaction between users via their avatars, because providing audio interaction is too difficult or costly.
Limiting the size and complexity of the rendered environment:
   A virtual environment implementation may only allow up to a low maximum number of avatars for the virtual environment, or partition the avatars so that only a low maximum number can be present at any time in a given “scene” in the virtual environment, or permit only a limited number of users at a time to interact using emissions of streaming data.
No per-avatar rendering of the streaming data:
   Avatars may be limited to speaking and listening only on an open “party line”, with all sounds, or all sounds from the “scene” in the virtual environment, present all the time, and all avatars being given the same rendering of all the sounds.
Unrealistic rendering:
   Avatars may be able only to interact audibly when the avatars' users join an optional “chat session”, for example a virtual intercom, with the speech of the avatars' users rendered at the original volumes and without direction, regardless of the virtual locations of the avatars in the environment.
Limited implementation for environmental media:
   Because of the difficulties in supporting streaming data, environmental media such as backgrounds sound for a waterfall may only be supported as sound generated locally in a client component for each user, such as playing a digital recording in a repeating loop, rather than as an emission in the virtual environment.
Undesirable side-effects from control of streaming media:
   In a number of existing systems for providing support for streaming data, a separate control protocol is used in the network is used to manage the flow of streaming data. One side effect is, due in part to the known problem of transmission delays on a network, a control event to change the flow of streaming data—such as to “mute” streaming data from a particular source, or to change the delivery of streaming data from being delivered to a first avatar to being delivered to a second avatar—may result in the change not taking place until after a noticeable delay: the control and delivery operations are not sufficiently synchronized.

### OBJECT OF THE INVENTION

It is an object of this invention to provide scalable techniques for dealing with emissions in virtual reality systems that produce per-avatar renderings. It is another object of the invention to filter emissions using psycho-acoustic principles. It is still another object of the invention to provide techniques for rendering emissions in the devices at the edges of a networked system.

### BRIEF SUMMARY OF THE INVENTION

In one aspect, an object of the invention is achieved by a filter in a system that renders an emission represented by a segment of streaming data. The emission is rendered by the system as perceived at a point in time from a point of perception from which the emission is potentially perceivable. Characteristics of the filter include:
the filter is associated with the point of perception.
the filter has access to
   current emission information for the emission represented by the segment of streaming data at the point in time; and
   current point of perception information for the filter's point of perception at the point of time represented by the segment of streaming data.

The filter makes a determination from the current point of perception information and the current emission information whether the emission represented by the segment's streaming data is perceptible at the filter's point of perception. The system does not use the segment in rendering the emission at the filter's point of perception when the determination indicates that the emission represented by the segment's streaming data is not perceptible at the point of time at the filter's point of perception.

In another aspect, the filter is a component of a virtual reality system that provides a virtual environment in which sources in the virtual environment emit emissions which are potentially perceived by avatars in the virtual environment. The filter is associated with an avatar and determines whether an emission represented by a segment is perceptible in the virtual environment by the avatar at the avatar's current point of perception. If it is not, the segment representing the emission is not used in rendering the virtual environment for the avatar's point of perception.

Upon perusal of the following Drawings and Detailed Description, other objects and advantages will be apparent to those skilled in the arts to which the invention pertains.

### BRIEF DESCRIPTION OF THE SEVERAL VIEWS OF THE DRAWINGS

FIG. 1 shows a conceptual overview of the filtering techniques.

FIG. 2 shows a scene in an exemplary Virtual environment. In the scene, users of the virtual environment who are represented by avatars are having a conference by having their avatars meet at a particular location in the virtual environment.

FIG. 3 shows a conceptual view of the contents of a segment of streaming data in a preferred embodiment.

FIG. 4 shows a specification of a portion of the SIREN14-3D V2 RTP Payload format.

FIG. 5 shows the operation of Stage 1 and Stage 2 filtering.

FIG. 6 shows greater detail of Stage 2 filtering.

FIG. 7 illustrates an adjacency matrix.

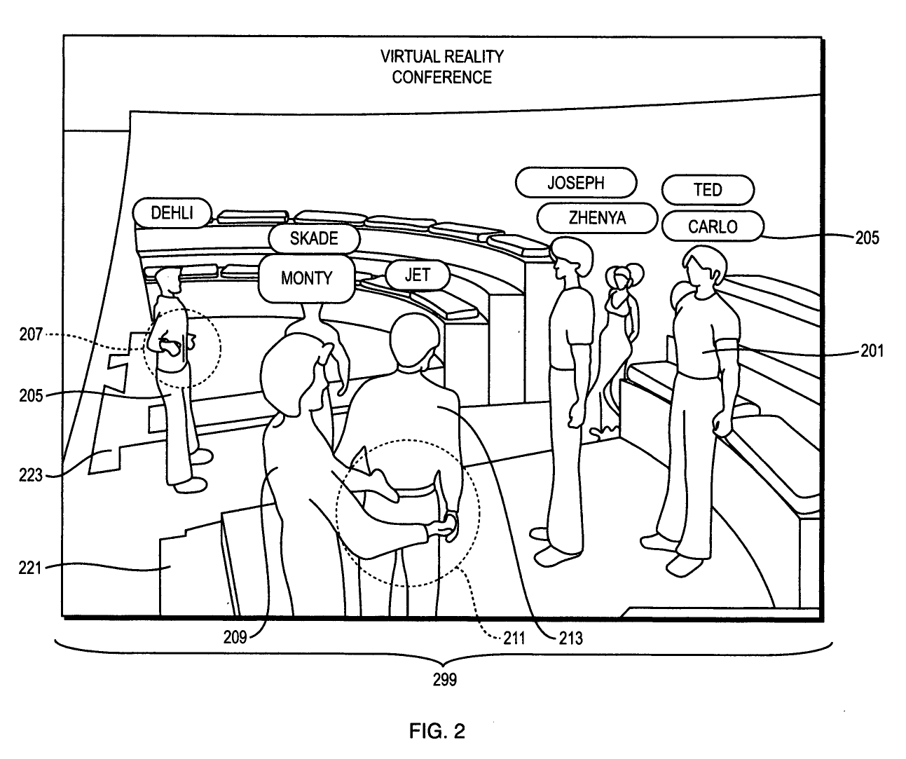

Reference numbers in the drawings have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

The following Detailed Description of the invention discloses an embodiment in which the virtual environment includes sources of audible emissions and the audible emissions are represented by streaming audio data.

The principles of the techniques described herein may be used with any kind of emission.

### Overview of the Inventive Techniques

In this preferred embodiment, a virtual reality system, such as the kind exemplified by Second Life, is implemented in a networked computer system. The techniques of this invention are integrated into the virtual reality system. Streaming data representing sound emissions from sources of the virtual environment are communicated as segments of streaming audio data in data packets. Information about the source of a segment relevant to determining perceptibility of the segment of the emission to an avatar is associated with each segment. The virtual reality system does per-avatar rendering on a rendering component, such as a client computer. The rendering for the avatar is done on a client computer, and only the segments that would be audible to the avatar are sent via the network to the client computer. There, the segments are converted to audible output through headphones or speakers for the avatar's user.

An avatar need not be associated with a user, but may be any entity for which the virtual reality system makes a rendering. For example, an avatar may be a virtual microphone in the virtual environment. A recording made using the virtual microphone would be a rendering of the virtual environment that consisted of those audio emissions in the virtual environment that were audible at the virtual microphone.

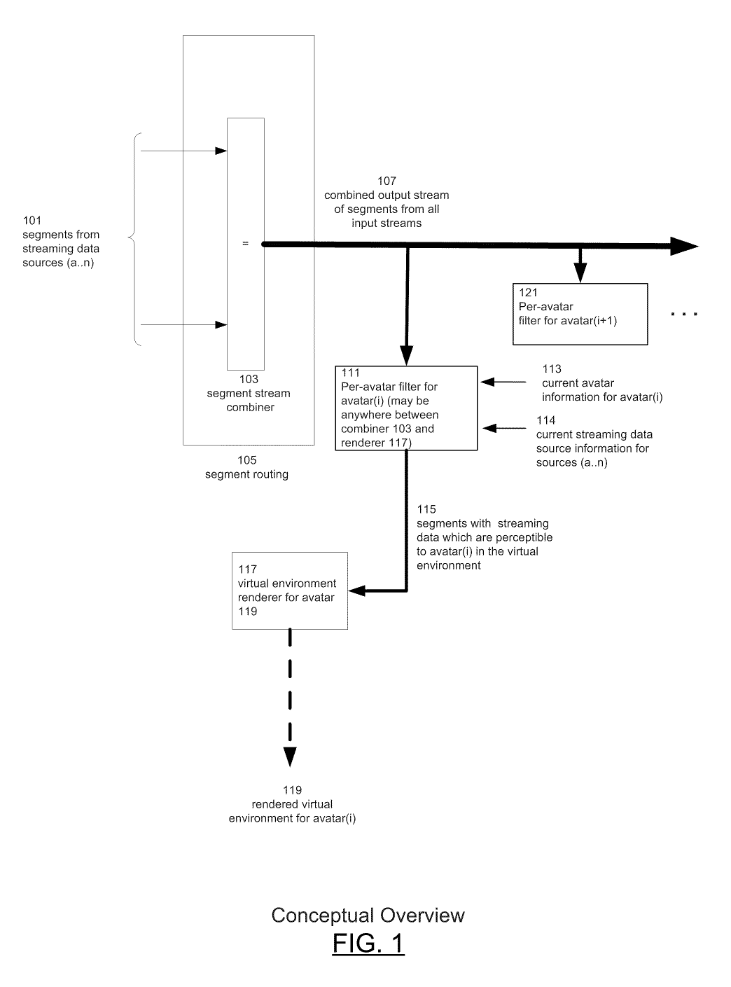

FIG. 1 shows a conceptual overview of the filtering techniques.

As shown at 101, segments of streaming data representing emissions from different sources in the virtual environment are received to be filtered. Each segment is associated with information about the source of the emission such as the location of the emission's source in the virtual environment and how intense the emission is at the source. In the preferred embodiment, the emissions are audible emissions and the intensity is the loudness of the emission at the source.

These segments are aggregated into a combined stream of all the segments by a segment routing component, shown at 105. The segment routing component 105 has a segment stream combiner component 103 that combines the segments into an aggregated stream, as illustrated at 107.

As shown at 107, the aggregated stream (consisting of all the sound streams' segments) is sent to a number of filter components. Two examples of the filter components are shown at 111 and 121—others are indicated by ellipses. There is a filter component corresponding to each avatar for which the virtual reality system is producing a rendering. The filter component 111 is the filter component for the rendering for avatar(i). Details for filter 111 are shown at 113, 114, 115, and 117: the other filters operate in a similar fashion.

The filter component 111 filters the aggregated stream 107 for those segments of streaming data for a given kind of emission that are needed to render the virtual environment appropriately for avatar(i). The filtering is based on current avatar information 113 of avatar (i) and current streaming data source information 114. Current avatar information 113 is any information about the avatar which affects avatar(i)'s ability to perceive the emission. What the current avatar information is depends on the nature of the virtual environment. For example, in a virtual environment which has a notion of location, current avatar information may include the location in the virtual environment of the avatar's organ for detecting the emission. In the following, a location in a virtual environment will often be termed a virtual location. Of course, where there are virtual locations, there are also virtual distances between those locations.

Current streaming data source information is current information about the sources of streaming data that affects avatar (i)'s ability to perceive an emission from a particular source. One example of current streaming data source information 114 is the virtual location of the source's emission generation component. Another is the intensity of the emission at the source.

As shown at 115, only the segments with streaming data that is perceptible to avatar (i) and therefore needed for rendering the virtual environment for avatar(i) at 119 are output from filter 111. In the preferred embodiment, perceptibility may be based on the virtual distance between the source and the perceiving avatar and/or on the relative loudness of the perceptible segments. The segments that remain after filtering by filter 111 are provided as input to a rendering component 117, which renders the virtual environment for the current point of perception of avatar(i) in the virtual environment.

### DETAILS OF A PREFERRED EMBODIMENT

In a presently-preferred embodiment, the emissions of the sources are audible sounds and the virtual reality system is a networked system in which the rendering of sound for an avatar is done in a client computer used by a user who is represented by an avatar.

### Overview of Segments in the Preferred Embodiment

As noted earlier, a user's client computer digitizes streaming sound input, and sends segments of the streaming data in packets over the network. Packets for transmitting data over a network are known in the art. We now discuss the content, also called the payload, of the streaming audio packets in the preferred embodiment. This discussion illustrates aspects of the techniques of this invention.

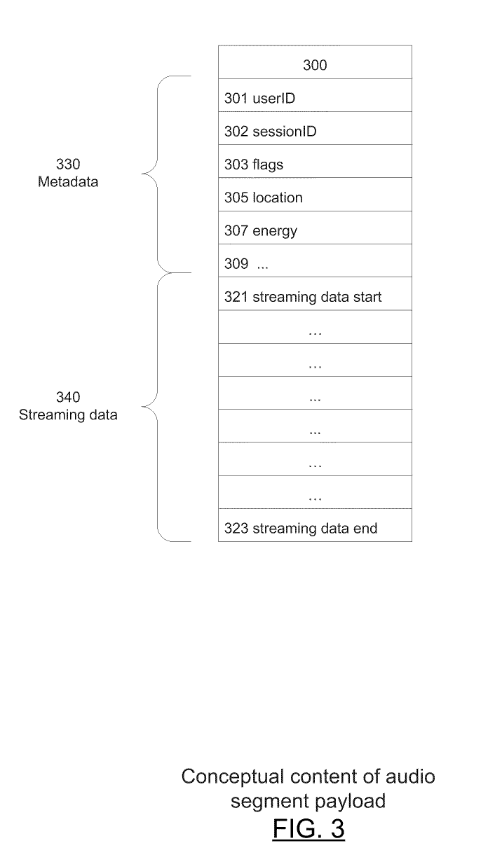

FIG. 3 shows in conceptual form the payload of a streaming audio segment.

In the preferred embodiment, an avatar may not only perceive audible emissions, but also be a source for them. Further, the virtual location of the avatar's speech generator may be different from the virtual location of the avatar's sound detector. Consequently, an avatar may have a different virtual location as a source of sound than it has as a perceiver of sound.

Element 300 shows in conceptual form the payload of a streaming data segment which is employed in the preferred embodiment. The braces at 330 and 340 show respectively the two main portions of the segment payload, namely a header with metadata information about the streaming audio data represented by the segment, and the streaming audio data itself. The metadata includes information such as the speaker location and the intensity. In the preferred embodiment, the segment's metadata is part of current streaming data source information 114 for the source of the emission represented by the streaming data.

In a preferred embodiment, metadata 330 includes:
A userID value 301 that identifies the entity that is the source that emitted the sound represented by the streaming data in the segment. For a source that is an avatar, this identifies the avatar.
A sessionID value 302 identifying a session. In the present context, a session is a set of sources and avatars. A set of flags 303 indicating further information, such as information about the source's state at the time of the emission representing this segment of streaming data. One flag indicates the nature of the location value 305, “speaker” or “listener” location.
The location 305, giving the current virtual location of the source of the emission represented by the segment in the virtual environment or for an avatar the current virtual location of the “listening” part of the avatar
A value 307 for the intensity of the sound energy, or intrinsic loudness of the emitted sound.
Additional metadata, if any, is represented at 309.

In the preferred embodiment, the intensity value 307 for audible emissions is computed from the intrinsic loudness of the sound, according to principles known in the relevant arts. Other kinds of emissions may employ other values to express the intensity of the emission. For example, for an emission that appeared as text in the virtual environment, an intensity value may be input separately by a user, or text that is all UPPER-CASE may be given an intensity value which is greater than text that is Mixed-Case or all lower-case. In an embodiment according to the techniques of this invention, intensity values may be chosen as a matter of design such that the intensity of different kinds of emissions can be compared with each other, such as in filtering.

The streaming data segment is shown at 340 and the associated brace. In the segment, the data portion of the segment is shown as starting at 321, continuing with all the data in the segment, and ending at 323. In the preferred embodiment, the data in the streaming data portion 340 represents the emitted sound in a compressed format: the client software that creates the segments also converts the audio data to a compressed representation, so that less data (and thus fewer or smaller segments) need to be sent over the network.

In the preferred embodiment, a compressed format based on a Discrete Cosine Transform is used to transform the signal data from the time domain into the frequency domain, and to quantize a number of sub-bands according to psychoacoustic principles. These techniques are known in the art, and are described for the SIREN14 codec standard at “Polycom® Siren14™, Information for Prospective Licensees”, www.polycom.com/common/documents/company/about_us/technology/siren14_g7221c/info_for_prospective_licensees.pdf.

Any representation of the emission may be employed. The representation may be in a different representation domain, and further the emission may be rendered in a different domain: speech emissions may be represented or rendered as text using speech-to-text algorithms or vice versa, sound emissions may be represented or rendered visually or vice versa, virtual telepathic emissions may be represented or rendered as a different kind of streaming data, and so forth.

### Architecture Overview of the Preferred Embodiment

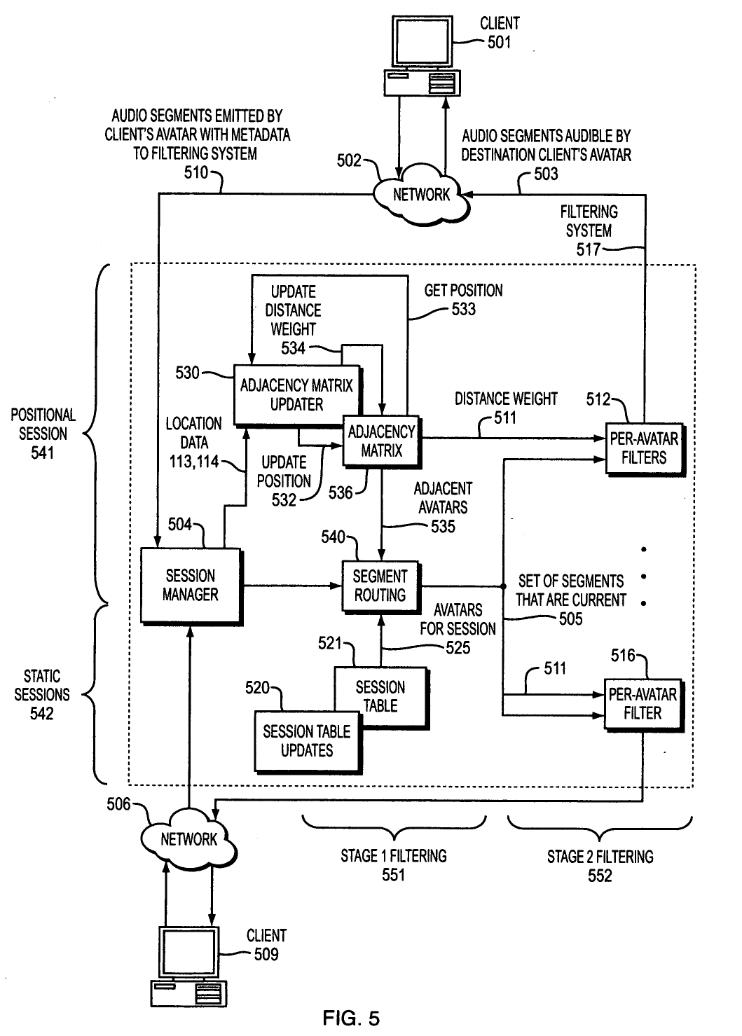

FIG. 5 is a system view of the preferred embodiment, showing the operation of Stage 1 and Stage 2 filtering. FIG. 5 will now be described in overview.

As noted in the discussion of FIG. 3, in the preferred environment, a segment has a field for a sessionID 302. Each segment which contains streaming data 320 belongs to a session and carries an identifier for the session the segment belongs to in field 320. A session identifies a group of sources and avatars, referred to as the members of the session. The set of sessions which have a source is a member is included in current source information 114 for that source. Similarly, the set of sessions of which an avatar is a member is included in current avatar information 113 for that avatar. Techniques for representing and managing the members of a group and implementing systems to do so are familiar in the relevant arts. The representation of session membership is referred to in the preferred embodiment as the session table.

In a preferred embodiment, there are two kinds of sessions: positional sessions and static sessions. A positional session is a session whose members are sources of emissions and avatars for which the emissions from the sources are at least potentially detectable in the virtual environment. In the preferred embodiment, a given source of an audible emission and any avatar which can potentially hear an audible emission from the given source must be a member of the same positional session. The preferred embodiment has only a single positional session. Other embodiments may have more than one positional session. A static session is a session whose membership is determined by users of the virtual reality system. Any audible emission made by an avatar belonging to a static session is heard by every other avatar belonging to that static session, regardless of the locations of the avatars in the virtual environment. Static sessions thus work like telephone conference calls. The virtual reality system of the preferred embodiment provides a user interface which permits a user to specify the static sessions that their avatar belongs to. Other embodiments of filter 111 may involve different kinds of sessions or no sessions at all. One extension to the implementation of sessions in the presently-preferred embodiment would be a set of session ID special values which would indicate not a single session, but a group of sessions.

In the preferred embodiment, the kind of session that is specified by a segment's sessionID determines how the segment is filtered by filter 111. If the sessionID specifies a positional session, the segments are filtered to determine whether the avatar for the filter can perceive the source in the virtual environment. Segments which the avatar for the filter can perceive are then filtered by the relative loudness of the sources. In the latter filter, the segments from the positional session that are perceptible by the filter's avatar are filtered together with the segments from the static sessions of which the avatar is a member.

In the preferred embodiment, every source of an audible emission in the virtual environment makes segments for the audible emission which have the sessionID for the positional session; if the source is also a member of a static session and the emission is also audible in the static session, the source further makes a copy of each of the segments for the audible emission which have the sessionID for the static session. An avatar to which the audible emission is perceptible in the virtual environment and which is also a member of a static session in which the emission is audible may thus receive more than one copy of the segment in its filter. In the preferred embodiment, the filter detects the duplicates and passes only one of the segments on to the avatar.

Returning to FIG. 5: Elements 501 and 509 are two of a number of client computers. The client computers are generally ‘personal’ computers, with hardware and software for the integrated system implementation with the virtual environment: for example, the client computer has an attached microphone, keyboard, display, and headphones or speakers, and has software for performing client operations of the integrated system. The client computers are connected to a network, as shown at 502 and 506 respectively. Each client may control an avatar as directed by a user of the client. The avatar can emit sounds in the virtual embodiment and/or hear sounds emitted by sources. The streaming data that represents the emissions in the virtual reality system is produced in the client when the client's avatar is a source of the emissions and is rendered in the client when the client's avatar can perceive the emissions. This is illustrated by the arrows in both directions between client computers and networks, such as between client 501 and network 502, and between client 509 and network 506.

In the preferred embodiment, network connections for segments and streaming data between components such as client 501 and the filtering system 517 employ standard network protocols such as the RTP and SIP network protocols for audio data—RTP and SIP protocols and many other techniques for network connections and connection management that are suitable are known in the art. A feature of RTP that is important in the present context is that RTP supports management of data by its arrival time, and upon a request for data which includes a time value, can return that data which have an arrival time which is the same or less recent than the time value. Segments which the virtual reality system of the preferred embodiment requests from RTP as just described are termed in the following current segments.

The networks at 502 and 506 are shown as separate networks in FIG. 5, but of course may be the same network or interconnected networks.

Referring to element 501, as a user associated with an avatar in the virtual environment speaks into the microphone at a client computer such as 501, software of the computer converts the sound to segments of streaming data in a compressed format with metadata, and sends the segment data in segments 510 over the network to the filtering system 517. In the preferred embodiment, filtering system 517 is in a server stack in the integrated system, separate from the server stacks of the unintegrated virtual reality system.

The compressed format and the metadata are described below. The filtering system has per-avatar filters 512 and 516 for the clients' avatars. Each per-avatar filter filters streaming data representing audible emissions from a number of sources in the virtual environment. The filtering determines the segments of streaming data representing audible emissions that are audible to a particular client's avatar, and sends the streaming audio for the audible segments over the network to the avatar's client. As shown at 503, segments that are audible to an avatar representing the user of client 501 are sent over the network 502 to client 501.

Associated with each source of emissions is current emission source information: current information about the emission and its source and/or information about its source where the information may vary in real time. Examples are the quality of the emission at its source, the intensity of the emission at the source, and the location of the emission source.

In this preferred embodiment, current emission source information 114 is obtained from metadata in segments representing emissions from the source.

In the preferred embodiment, filtering is performed in two stages. The filtering process employed in filtering system 517 is broadly as follows:

For segments belonging to the positional session:
Stage 1 filtering: For a segment and an avatar, the filtering process determines the virtual distance separating the source of the segment from the avatar, and whether the source of the segment would be within a threshold virtual distance of the avatar. The threshold distance defines the audible vicinity for the avatar; emissions from sources outside this vicinity are not audible to the avatar. Segments which are outside the threshold are not passed on to filtering 2. This determination is done efficiently by considering metadata information for the segment such as the sessionID described above, current source information for the source 114, and the current avatar information for the avatar 113. This filtering generally reduces the number of segments that must be filtered as described for Filtering 2 below.

For segments with a sessionID of a static session:
Stage 1 filtering: For a segment and an avatar, the filtering process determines whether the filter's avatar is a member of the session identified by the sessionID of the segment. If the filter's avatar is a member of the session, the segment is passed on to filtering 2. This filtering generally reduces the number of segments to be filtered as described for Filtering 2 below.

For all segments which are within the threshold for the filter's avatar or belong to a session of which the avatar is a member:
Stage 2 filtering: The filtering process determines the apparent loudness of all segments for this avatar which are passed by the Stage 1 filtering. The segments are then sorted by their apparent loudness, duplicate segments from different sessions are removed, and a subset consisting of the three segments with the greatest apparent loudness is sent to the avatar for rendering. The size of the subset is a matter of design choice. The determination is done efficiently by considering the metadata. Duplicate segments are ones that have the same userID and different sessionIDs.

The components of filter system 517 that filter only segments belonging to the positional session are indicated by upper brace 541 brace upper on the right at 541, and the components that filter only segments belonging to static sessions are indicated by lower brace 542.

The components that do with Stage 1 filtering are indicated by the brace bottom on the left at 551, and the components that do Stage 2 filtering are indicated by the brace bottom on the right at 552.

In the preferred embodiment filter system component 517 is located on a server in the virtual reality system of the preferred embodiment. A filter for an avatar may however in general be located at any point in the path between the source of the emission and the rendering component for the avatar the filter is associated with.

Session manager 504 receives all incoming packets and provides them to segment routing 540, which, and performs Stage 1 filtering by directing the segments that are perceptible to a given avatar either via the positional session or a static session to the appropriate per-avatar filters for Stage 2 filtering

As shown at 505, sets of segments output from segment routing component 540 are input to representative per-avatar filters 512 and 516 for each avatar. Each avatar that can perceive the kind of emission represented by the streaming data has a corresponding per-avatar filter. Each per-avatar filter selects from the segments belonging to each source those segments that are audible to the destination avatar, sorts them in terms of their apparent loudness, removes any duplicate segments, and sends the loudest three of the remaining segments to the avatar's client over the network.

### Details of Content of Streaming Audio Segments

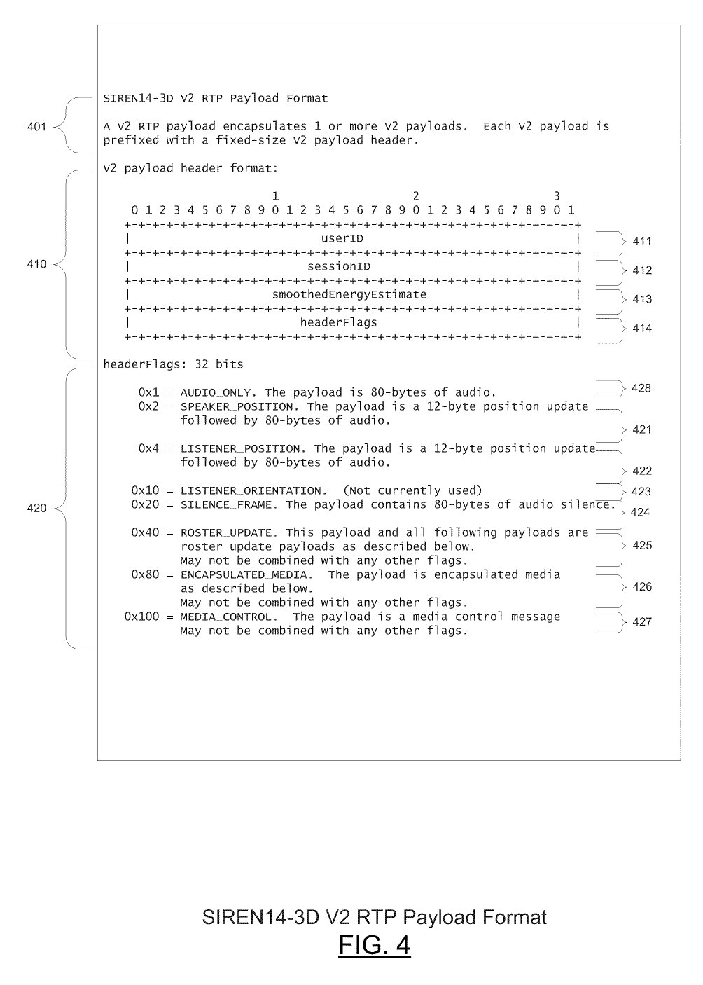

FIG. 4 shows a more detailed description of the relevant aspects of the payload format for these techniques. In the preferred embodiment, the payload format may also include non-streaming data used by the virtual reality system. The integrated system of the preferred embodiment is exemplary of some of the many ways in which the techniques can be integrated with a virtual reality system or other application. The format used in this integration is referred to as the SIREN14-3D format. The format makes use of encapsulation to carry multiple payloads in one network packet. The techniques of encapsulation, headers, flags and other general aspects of packets and data formats are well known in the art, and accordingly are not described in detail here. For clarity, in cases where details of the integration with or operation of the virtual environment are not germane to describing the techniques of the invention, those details are omitted from this discussion.

Element 401 states that this part of the specification concerns a preferred SIREN14-3D version V2 RTP version of this format, and that one or more encapsulated payloads are carried by a network packet that is transmitted across the network using an RTP network protocol.

In the presently-preferred embodiment, a SIREN14-3D version V2 RTP payload consists of an encapsulated media payload with audio data, followed by zero or more other encapsulated payloads. The content of each encapsulated payload is given by header Flags flag bits 414, described below.

Element 410 describes the header portion of an encapsulated payload in the V2 format. Details of element 410 describe individual elements of metadata in the header 410.

As shown at 411, the first value in the header is a userID value that is 32 bits in size—this value identifies the source of the emission for this segment.

This is followed by a 32-bit item named sessionID 412. This value identifies the session the segment belongs to.

Following this is an item for the intensity value for this segment, named smoothedEnergyEstimate 413. Element 413 is the metadata value for the intensity value for the intrinsic loudness of the segment of audio data that follows the header: the value is an integer value in units of the particular system implementation.

In the preferred embodiment, the smoothedEnergyEstimate value 413 is a long-term “smoothed” value determined by smoothing together a number of original or “raw” values from the streaming sound data. This prevents undesirable filter results that could otherwise be the result from sudden moments of noise (such as “clicks”) or data artifacts caused by the digitizing process for sound data in the client computer that may be present in the audio data. The value in this preferred embodiment is computed for a segment using techniques known in the art for computing the audio energy reflected by the sound data of the segment. In the preferred embodiment, a first order Infinite Impulse response (IIR) filter with an ‘alpha’ value of 0.125 is used to smooth out the instantaneous sample energy E=x[j]*x[j] and produce an intensity value for the energy of the segment. Other methods of computing or assigning an intensity value for the segment may of course be used as a matter of design choice.

Element 413 is followed by headerFlags 414, consisting of 32 flag bits. A number of these flag bits are used to indicate the kind of data and format that follows the header in the payload.

420 shows a portion of the set of flag bit definitions that may be set in the headerFlags 414.

Element 428 describes the flag for an AUDIO_ONLY payload, with the numeric flag value of 0×1: this flag indicates the payload data consists of 80 bytes of audio data in a compressed format for a segment of streaming audio

Element 421 describes the flag for a SPEAKER_POSITION payload, with the numeric flag value of 0×2: this flag indicates that the payload data includes metadata consisting of the current virtual location of the “mouth” or speaking part of the source avatar. This may be followed by 80 bytes of audio data in a compressed format for a segment of streaming audio. The location update data consist of three values for the X, Y and Z location in co-ordinates of the virtual environment.

In the preferred embodiment, each source which is an avatar sends a payload with SPEAKER_POSITION information 2.5 times a second.

Element 422 describes the flag for a LISTENER_POSITION payload, with the numeric flag value of 0×4: this flag indicates that the payload data includes metadata consisting of the current virtual location of the “ears” or listening part of the avatar. This may be followed by 80 bytes of audio data. The location information allows the filter implementation to determine which sources are in the particular avatar's “audible vicinity”. In the preferred embodiment, each source which is an avatar sends a payload with LISTENER_POSITION information 2.5 times a second.

Element 423 describes the flag for a LISTENER_ORIENTATION payload, with the numeric flag value of 0×10: this flag indicates that the payload data includes metadata consisting of the current virtual orientation or facing direction of the listening part of the user's avatar. This information allows the filter implementation and the virtual environment to extend the virtual reality so that an avatar can have “directional hearing” or a special virtual anatomy for hearing, like the ears of a rabbit or a cat.

Element 424 describes the flag for a SILENCE_FRAME payload, with the numeric flag value of 0×20: this flag indicates that the segment represents silence.

In the preferred embodiment, if a source has no audio emission segments to send, the source send payloads of SILENCE_FRAME payloads as necessary to send SPEAKER_POSITION and LISTENER_POSITION payloads with location metadata as described above.

### Additional Aspects of the Segment Format for Filtering Operation

In the preferred embodiment, audio emissions from an avatar are never rendered for that same avatar, and do not enter into any filtering of streaming audio data for that avatar: this is a matter of design choice. This choice is in keeping with the known practice of suppressing or not rendering “side-tone” audio or video signals in digital telephony and video communications. An alternative embodiment may process and may filter emissions from a source that is also an avatar when determining what is perceptible for that same avatar.

As is readily appreciated, the filtering techniques described here can be integrated with management functions of the virtual environment to achieve greater efficiency both in filtering streaming data, and in the management of the virtual environment.

### Details of Filter Operation

The operation of filtering system 517 will now be described in detail.

The session manager 504, at a period of 20 milliseconds, reads a time value from an authoritative master clock. The session manager then obtains from the connections for incoming segments all those segments that have an arrival time the same as that time value or earlier. If more than one segment from a given source is returned, the less recent segments from that source are discarded. The segments remaining are referred to as the set of current segments. Session manager 504 then provides the set of current segments to segment routing component 540, which routes the current segments to a specific per-avatar filters. The operation of the segment routing component will be described below. Segments which are not provided to segment routing component 540 are not filtered and are thus not delivered for rendering to an avatar.

Segment routing component 540 does stage 1 filtering on segments belonging to the positional session using adjacency matrix 535, which is a data table that records which sources are within the audibility vicinity of which avatars: the audibility vicinity of an avatar is the portion of the virtual environment that is within a specific virtual distance of the hearing part of the avatar. In the preferred embodiment, this virtual distance is 80 units in the virtual coordinate units of the virtual reality system. Sound emissions that are farther away from the hearing part of an avatar than this virtual distance are not audible to the avatar.

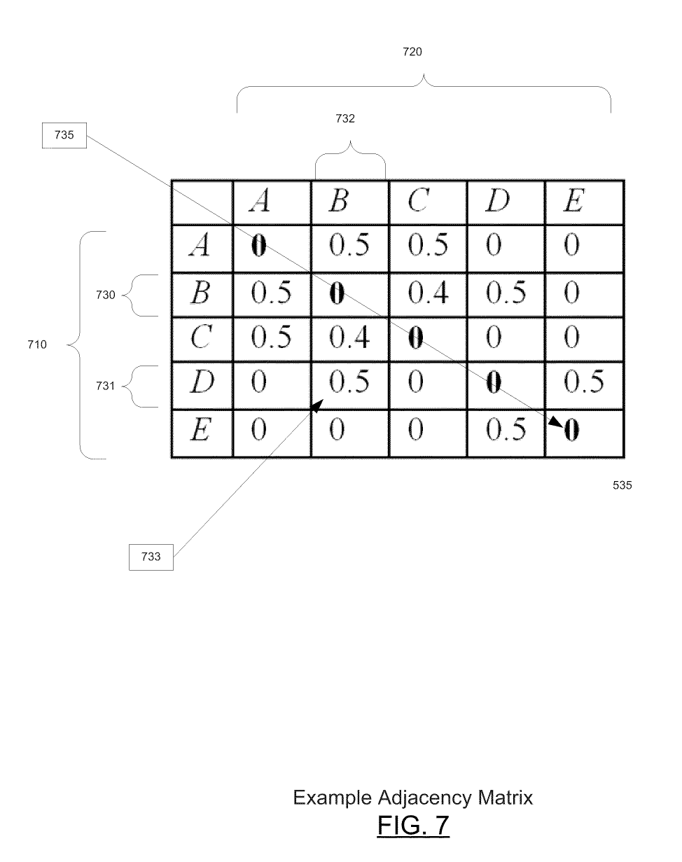

Adjacency matrix 535 is illustrated in detain in FIG. 7. Adjacency matrix 535 is a two-dimensional data table. Each cell represents a source/avatar combination and contains a distance-weight value for the source-avatar combination. The distance weight value is a factor for adjusting the intrinsic loudness or intensity value for a segment according to the virtual distance between the source and the avatar: the distance-weight factor is less at greater virtual distance.

In this preferred embodiment, the distance weight value is computed by a clamped formula for roll-off as a linear function of distance. Other formulae may be used instead: for example, a formula may be chosen that is approximate for more efficient operation, or that includes effects such as clamping, or minimum and maximum loudness, more dramatic or less dramatic roll-off effects, or other effects. Any formula appropriate to the particular application may be used as a matter of design choice, for example, any from the following exemplary references:
“OpenAL 1.1 Specification and Reference”,
   Version 1.1, June 2005, by Loki Software (www.openal.org/openal_webstf/specs/OpenAL11Specification.pdf)
IASIG I3DL2 “Interactive 3D Audio Rendering Guidelines, Level2.0”,
   Sep. 20, 1999, by MIDI Manufacturers Association Incorporated (www.iasig.org/pubs/3d12v1a.pdf.)

The adjacency matrix has one row for each source, shown in FIG. 7 along the left side at 710 as A, B, C, etc. There is one column for each destination or avatar, as shown across the top at 720 as A, B, C, and D. In the preferred embodiment, an avatar is also a source: accordingly for an avatar B there a column B at 732 as well as a row B at 730, but there may be more or fewer sources than avatars, and sources which are not avatars and vice versa.

Each cell in the adjacency matrix is at the intersection of a row and column (source, avatar). For example, row 731 is the row for source D, and column 732 is the column for avatar B.

Each cell in the adjacency matrix contains either a distance weight value of 0, indicating that the source is not within the audibility vicinity of the avatar or is not audible to the avatar, or a distance weight value between 0 and 1: this value is the distance weight factor computed according to the formula described above, which is the factor by which an intensity value should be multiplied to determine the apparent loudness for an emission from that source at that destination. The cell 733 at the intersection of the row and the column hold the value of the weight factor for (D, B), which is shown in this example as 0.5.

The weight factor is computed using the current virtual location of the source represented by the cell's row and the current virtual location of the “ears” of the avatar represented by the column. In the preferred embodiment, the cell for each avatar and itself is set to zero and is not changed, in keeping with treatment for side-tone audio known in the art of digital communications, that sound from an entity which is a source is not transmitted to the entity as a destination. This is shown in the diagonal set of values 735, which are all zero: the distance weight factor in the cell (source=A, avatar=A), is zero, as are all the other cells in this diagonal. The values in the cells along diagonal 735 are shown in bold text for better readability.

In the preferred embodiment, the sources and other avatars send segments of streaming data with position data for their virtual locations 2.5 times a second. When a segment contains location, the session manager 504 passes the location values and the userID of the segment 114 to the adjacency matrix updater 530 to update the location information associated with the segment's source or other avatar in the adjacency matrix 535, as indicated at 532.

The adjacency matrix updater 530 periodically updates the distance weight factors in all cells of the adjacency matrix 521. In the preferred embodiment, this is done at periods of 2.5 times per second, as follows:

The adjacency matrix updater 530 obtains the associated location information for each row of the adjacency matrix 535 from the adjacency matrix 535. After obtaining this location information for a row, the adjacency matrix updater 530 obtains the location information for the hearing part of the avatar for each column of the adjacency matrix 535. Obtaining the location information is indicated at 533.

After obtaining the location information for the hearing part of an avatar, the adjacency matrix updater 530 determines the virtual distance between the source location and the location of the hearing part of the avatar. If the distance is greater than the threshold distance for the audibility vicinity, the distance weight for the cell corresponding to the row of the source and the column of the avatar in adjacency matrix 535 is set to zero, as shown. If the source and the avatar are the same, the value is left unchanged as zero as noted above. Otherwise, the virtual distance between source X and destination Y is computed, and a distance weight value computed according to the formula described above: the distance weight value for the cell is set to this value. Updating the distance weight value is illustrated at 534.

When segment routing component 540 determines that a source is outside the audibility vicinity of an avatar, segment routing component 540 does not route segments from the source to the stage 2 filter for the avatar, and thus these segments will not be rendered for the avatar.

Returning to the session manager 504, session manager 504 also provides the current segments belonging to static sessions to segment routing component 540, for potential delivery to Stage 2 filter components such as those illustrated at 512 and 516. The segment routing component 540 determines the set of avatars to which a particular segment for an emission should be sent and sends the segment to the 1 Stage 2 filters for those avatars. The segments from a particular source which are sent to a particular stage 2 filter during a particular time slice may include segments from different sessions and may include duplicate segments.

If the session ID value indicates a static session, the segment routing component accesses the session table, described below, to determine the set of all avatars that are members of that session. This is shown at 525. The segment routing component then sends the segment to the each of the Stage 2 filters associated with those avatars.

If the session ID value is the value of the positional session, the segment routing component accesses adjacency matrix 535. From the row of the adjacency matrix corresponding to the source of the packet, the segment routing component determines all the columns of the adjacency matrix that have a distance weight factor which is not zero, and the avatars of each such column. This is shown at 536, labeled “Adjacent avatars”. The segment routing component then sends the segment to each of the Stage 2 filters associated with those avatars.

The Stage 1 filtering for static sessions is done by use of the segment routing component 540 and the session table 521. Session table 521 defines membership in sessions. The session table is a two-column table: the first column contains a session ID value, and the second column contains an entity identifier such as an identifier for a source or avatar. An entity is a member of all sessions identified by the session ID value in all rows for which the entity's identifier is in the second column. The members of a session are all the entities appearing in the second column of all rows that have the session's session ID in the first column. The session table is updated by a session table updater component 520, which responds to changes in static session membership by adding or removing rows to or from the session update table. Numerous techniques for the implementation of both the session table 521 and the session table updater 520 are well known to practitioners of the relevant arts. When session table 521 indicates that a source for a segment and an avatar belong to the same static session, segment router 540 routes the segment to the stage 2 filter for the avatar.

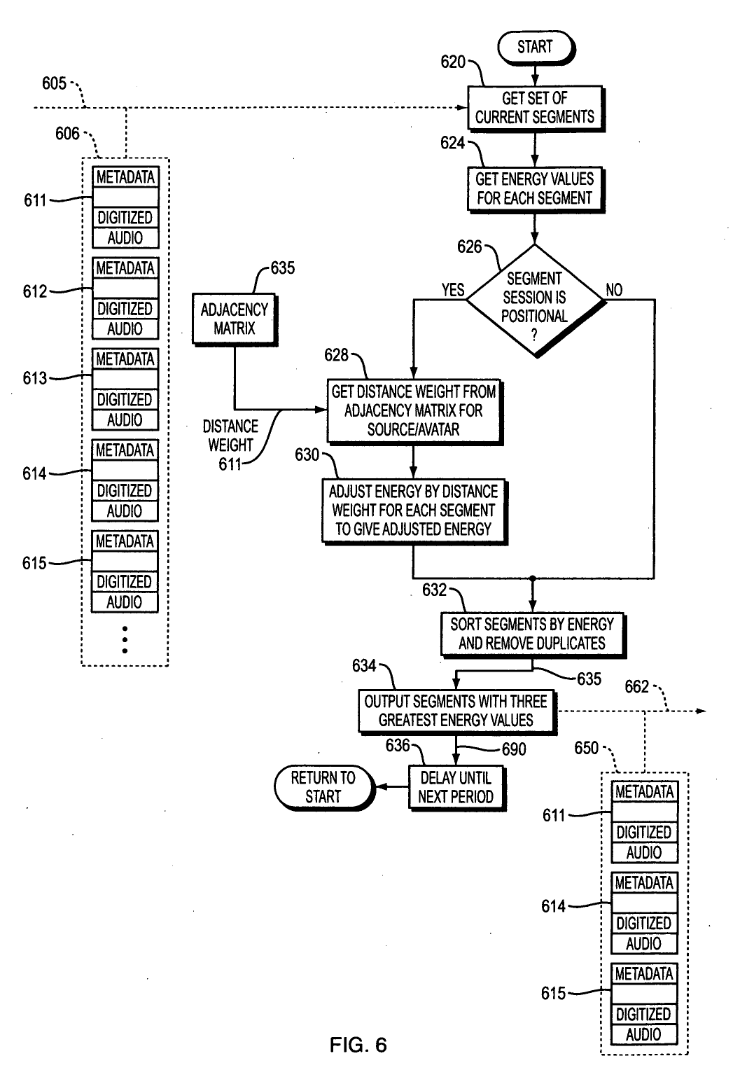

FIG. 6 shows the operation of a Stage 2 filtering component such as 512 of the preferred embodiment. Each Stage 2 filtering component is associated with a single avatar.

600 shows a set of current segments 505 delivered to the Stage 2 filtering component. A set of representative segments 611, 612, 613, 614 and 615 are shown. Ellipses illustrate that their may be any number of segments.

The start of Filtering 2 processing is shown at 620. The next set of current segments 505 is obtained as input. The steps of elements 624, 626, 628 and 630 are performed for each segment in the set of current segments obtained in step 620. 624 shows the step of getting from each segment, the energy value of the segment and the source id of the segment.

At 626, for each segment, the sessionID value is obtained. If the session ID value is that of the positional session, the next step is 628, as shown. If the session ID value is that of a static session, the next step is 632.

628 shows the step of getting from the adjacency matrix 535 the distance weight from the cell of the adjacency matrix 535 for the source that is the source of this segment, and the avatar that is the avatar for which this filter component is the Stage 2 filter component. This is indicated by the dotted arrow at 511.

630 shows the step of multiplying the energy value of the segment by the distance weight from the cell, to adjust the energy value for the segment. After all segments have been processed by steps 624, 626, 628, and 630, processing continues with step 632.

632 shows the step of sorting all the segments obtained in step 622 by the energy value of each segment. After the segments have been sorted, all but 1 of any set of duplicates is removed. 634 shows the step of outputting a subset of the segments obtained in 622 as output of the Filtering 2 filtering. In the preferred embodiment, the subset is the three segments with the greatest energy values as determined by the sorting step 632. The output is represented at 690, showing representative segments 611, 614, and 615.

Of course, following the techniques of this invention, selection of the segments to be output to the avatar may include sorting and selection criteria different from those employed in the preferred embodiment.

Processing continues from 634 to step 636, before continuing from 636 in a loop to the starting step at 620. 636 show that the loop is executed periodically at an interval of 20 milliseconds in the preferred embodiment.

### Client Operation for Rendering

In this preferred embodiment, segments representing audio emissions that are perceptible for a given avatar are rendered for that avatar according to the avatar's point of perception. For an avatar for a specific user, the rendering is performed on the user's client computer, and streams of audio data are rendered at an appropriate apparent volume and stereophonic or binaural direction according to the virtual distance and relative direction for the source and the user's avatar. Because the segments sent to the renderer include the metadata for the segment, the metadata that was used for filtering can also be used in the renderer. Further, the segment's energy value, which may have been adjusted during filtering 2, can be used in the rendering process. There is thus no need to transcode or modify the encoded audio data originally sent by the source, and the rendering thus does not suffer from any loss of fidelity or intelligibility. Rendering is of course also greatly simplified by the reduction in the number of segments to be rendered that has resulted from the filtering.

The rendered sound is output for the user by playing the sound over headphones or speakers of the client computer.

### Other Aspects of the Preferred Embodiment

As will be readily appreciated, there are many ways to implement or apply the techniques of this invention, and the examples given here are in no way limiting. For example, the filtering may be implemented in a distributed embodiment, in a parallel fashion, or employing virtualization of computer resources. Further, filtering according to the techniques can be performed in various combinations and at various points in a system, with choices being made as required to best utilize the virtual reality system's network bandwidth and/or processing power.

### Additional Kinds of Filtering, and Combinations of Multiple Kinds of Filtering

Any kind of filtering techniques may be employed that will separate segments that represent emissions that are perceptible to a particular avatar from segments that represent emissions that are not perceptible to the particular avatar. As shown in the preferred embodiment, previously, many kinds of filtering can be employed singly, in sequence, or in combination using techniques of this invention. Further, filtering according to the techniques of this invention can be used with any kind of emission and in any kind of virtual environment in which relationships between the source of an emission and the perceivers of an emission may vary in real time. Indeed, the preferred embodiment's use of relative loudness filtering with segments belonging to static segments is an example of the use of the techniques in a situation where filtering is not dependent on location. The technique used with the static segments may, for example be used in telephone conference call applications.

As is readily apparent, the ease and low cost with which the techniques here can be applied to many kinds of communications and streaming data are among the advantages of these techniques over prior art.

### Kinds of Applications

The techniques of this invention of course encompass a very broad range of applications. Readily apparent examples include:
An improvement to audio mixing and rendering of number of audio inputs for recordings, such as to render the aggregated audio for a point of perception in a virtual audio space environment such as a virtual concert hall.
Text messaging communications, such as when streams of text messaging data from a number of avatars must be displayed or rendered concurrently in a virtual environment. This is one of many possible examples of streaming visual data to which the techniques may be applied.
Filtering and rendering of streaming data for a real-time conference system, such as for a telephone/audio virtual conference environment.
Filtering and rendering of streaming data for sensory input in a virtual sensory environment.
Distribution of streaming data based on real-time geographic proximity of real-world entities, the entities being associated with an avatar in a virtual environment.

The kinds of information needed to filter the emissions of the sources will depend on the properties of the virtual environment and the properties of the virtual environment may in turn depend on the application for which it is intended. For example, in a virtual environment for a conferencing system, the positions of the conferees relative to each other may not be important, and in such a situation, filtering might be done only on the basis of information such as relative intrinsic loudness of the conferees' audio emissions and the association of a conferee with a particular session.

Combination and Integration of Filtering with Other Processing

Filtering may also be combined with other processing to good effect. For example, certain streams of media data may be identified in a virtual environment as “background sounds”, such as the sound of flowing water of a virtual fountain in the virtual environment. The designers of the virtual environment, as part of the integration of these techniques, may prefer that background sounds not be filtered identically to other streaming audio data, and not cause other data to be filtered out, but instead the data for background sounds be filtered and processed to be rendered at lesser apparent loudness when there are other streaming data that may otherwise have been masked and filtered. Such an application of the filtering techniques permits background sounds to be generated by a server component in a virtual environment system, instead of being generated locally by a rendering component in a client component.

It is also readily apparent that same filtering according to these techniques can be applied to emissions and to streaming data of different kinds For example, different users may communicate via the virtual environment by different kinds of emissions—a hearing-impaired user may communicate in the virtual environment by visual text messaging, and another user may communicate by speech sound—and a designer may thus choose to have the same filtering applied to the two kinds of streaming data in an integrated fashion. In such an implementation, for example, a filtering may filter according to metadata and current avatar information such as source location, intensity, and avatar location, for two different kinds of emissions without regard to the two emissions being of different of different kinds. All that is required is that the intensity data be comparable.

As noted earlier, the techniques of this invention can be used to reduce the amount of data that must be rendered, and thus it becomes much more possible to move rendering of real-time streaming data to the “edges” of a networked virtual reality system—rendering on the destination clients rather than adding to the burden of doing rendering on a server component. In addition, a design may employ these techniques to reduce the amount of data to the extent that functionality previously implemented on the client, such as recording, can be performed on server components: thus allowing a designer for a particular application to choose to reduce the cost of clients, or to provide virtual functionality not supported on the client computer or its software

It will be immediately appreciated that the flexibility and power to combine filtering with routing and other processing and to do so at much improved implementation cost are among the many advantages of the new techniques disclosed here.

### Summary of Some Additional Aspects of Applying the Techniques

In addition to the above, there are of course other useful aspects of the techniques. A few further examples are noted here of the many that are apparent on consideration:

In the preferred embodiment, the current emission source information, such as that provided by metadata relating to location and orientation, may be further useful for rendering streaming media data stereophonically or binaurally at the final point of rendering, so that the rendered sounds are perceived as coming from the appropriate relative direction—from the left, from the right, above, and so forth. Thus, the inclusion of this associated information for filtering may thus have further synergistic advantages in rendering, in addition to those already mentioned.

In part due to their advantageous and novel simplicity over the prior art, a system employing the techniques of this invention can operate very quickly, and further a designer may quickly understand and appreciate the techniques themselves. Parts of the techniques lend themselves especially well to implementations in special hardware or firmware. As a matter of design choice, the techniques can be integrated with infrastructure like that of network packet routing systems: these new techniques can thus be implemented with very efficient new use of kinds of components that are easily and widely available, and of new kinds of components that may become available in the future The techniques may of course also be applied to kinds of emissions not yet known, and to kinds of virtual environments not yet implemented.

### CONCLUSION

The foregoing Detailed Description has disclosed to those skilled in the relevant technologies how to use the inventors' scalable techniques for providing real-time per-avatar streaming data in virtual reality systems that employ per-avatar rendered environments and has further disclosed the best mode presently known to the inventors of implementing their techniques.

It will be immediately apparent to those skilled in the relevant technologies that there are many possible applications of the techniques in any area where streaming data is being rendered and there is a need to reduce the network bandwidth and/or processing resources needed to deliver or render the streaming data. The filtering techniques are particularly useful where the streaming data represents emissions from sources in a virtual environment and is being rendered as required for different points of perception in the virtual environment. The basis on which the filtering is done will of course depend on the nature of the virtual environment and on the nature of the emissions. The psychoacoustic filtering techniques disclosed herein are further useful not just in virtual environments, but in any situation in which audio from multiple sources is rendered. Finally, the technique of using metadata in the segments containing the streaming data both in the filtering and in rendering the streaming data at the renderer results in substantial reduction in both network bandwidth requirements and processing resources.

It will further be immediately apparent to those skilled in the relevant technologies that there are as many ways of implanting the inventors' techniques as there are implementers. The details of a given implementation of the techniques will depend on what the streaming data is representing, the kind of environment, virtual or otherwise, the techniques are being used with, and the capabilities of the components of the system in which the techniques are used as regards the amount and location of the system's processing resources and the available network bandwidth.

For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

What is claimed is:

1. A filter in a virtual reality system, the virtual reality system rendering a virtual environment as perceived by an avatar in the virtual environment, the virtual environment including a source of an emission in the virtual environment whose perceptibility in the virtual environment by the avatar varies in real time, and the emission being represented in the virtual reality system by segments containing streaming data, and
the filter being characterized in that:
the filter is associated with the avatar,
the filter has access to
current emission source information for the emission represented by the segment's streaming data; and
current avatar information for the filter's avatar; and
the filter making a first determination from the current avatar information and the current emission source information for the segment's streaming data whether the emission represented by the segment's streaming data is perceptible to the avatar, and a second determination whether the emission should be rendered to the avatar in view of other perceptible emissions, the virtual reality system not using the segment in rendering the virtual environment when the first determination indicates that the emission represented by the segment's streaming data is not perceptible to the avatar or the second determination indicates that the emission should not be rendered to the avatar.

2. The filter set forth in claim 1 further characterized in that:
the first determination whether the emission is perceptible is based on a physical property of the emission in the virtual environment.

3. The filter set forth in claim 1 further characterized in that:
the avatar additionally perceives an emission that the avatar cannot perceive in the virtual environment on the basis of membership in a group at least of avatars.

4. The filter set forth in claim 2 further characterized in that:
the physical property is a distance between the emission and the avatar in the virtual environment which renders the emission imperceptible to the avatar.

5. The filter set forth in claim 1 further characterized in that:
there is a plurality of emissions in the virtual reality that are perceptible to the avatar; and
the second determination whether the emission should be rendered to the avatar in view of other perceptible emissions is based on whether the emission is psychologically perceptible by the avatar relative to other perceptible emissions.

6. The filter set forth in claim 5 further characterized in that:
as perceived by the avatar, the emissions of the plurality have differing intensities; and
whether the emission is psychologically perceptible by the avatar is determined by a relative intensity of the emission relative to the intensities of other emissions that are perceptible to the avatar.

7. (canceled)

8. The filter set forth in claim 1 further characterized in that:
the filter makes the second determination only if the first determination determines that the emission is perceptible.

9. The filter set forth in any one of claims 1 through 6 and 8 further characterized in that:
the emission is an audible emission that is audible in the virtual environment.

10. The filter set forth in any one of claims 1 through 6 and 8 further characterized in that:
the emission is a visible emission that is visible in the virtual environment.

11. The filter set forth in any one of claims 1 through 6 and 8 further characterized in that:
the emission is a haptic emission that is perceived by touch in the virtual environment.

12. The filter set forth in any one of claims 1 through 6 and 8 further characterized in that:
the virtual reality system is a distributed system of a plurality of components, the components being accessible to each other by a network, the emission being produced in a first component of the plurality and used to render a virtual environment in another component, the segments being transported between the component and the other component via the network, and the filter being located anywhere in the distributed system between the first component and the second component.

13. The filter set forth in claim 12 further characterized in that:
the distributed system's components includes at least one client and a server, the emissions being produced and/or rendered for the avatar in the client and the server including the filter, the server receiving the segments representing the emissions from the client and employing the filter to select segments to be provided to the client to be rendered for the avatar.

14. The filter set forth in any one of claims 1 through 6 and 8 further characterized in that:
the current emission source information for the emission represented by the segment's streaming data is also contained in the segment.

15. The filter set forth in any one of claims 1 through 6 and 8 further characterized in that:
the segments further include current avatar information segments from which the filter obtains the current avatar information for the filter's avatar.

16. A filter in a system that renders an emission represented by a segment of streaming data, the emission being rendered by the system as perceived at a point in time from a point of perception from which the emission is potentially perceivable and
the filter being characterized in that:
the filter is associated with the point of perception;
the filter has access to
current emission information for the emission represented by the segment's streaming data at the point in time; and
current point of perception information for the filter's point of perception at the point in time; and
the filter makes a first determination from the current point of perception information and the current emission information whether the emission represented by the segment's streaming data is perceptible at the filter's point of perception, and a second determination whether the emission should be rendered to the filter's point of perception in view of other perceptible emissions, the system not using the segment in rendering the emission at the filter's point of perception when the first determination indicates that the emission represented by the segment's streaming data is not perceptible at the filter's point of perception or the second determination indicates that the emission should not be rendered to the filter's point of perception.

17. A filter in a system for rendering sounds from a plurality of sources, the sounds from the sources having a property that varies in real time and the sounds from each source of the plurality being represented as segments in a stream of segments produced by the source,
the filter being characterized in that:
the filter receives time-sliced streams of segments from the sources; and
the filter selects segments belonging to a time slice from the streams for rendering according to a psychoacoustic effect which results from interactions of the property for the sounds represented by the segments belonging to the time slice.

18. A renderer that renders emissions from a plurality of sources, the emissions varying in real time and the emissions from each of the sources being represented by segments containing streaming data,
the renderer being characterized in that:
a segment from a source includes information about the source's emission in addition to the streaming data, the information about the source's emission in the segment further being used to filter the segment such that a subset including only a predetermined number of the segments representing the emissions from the plurality of sources is available to the renderer; and
the renderer employs the information about the source's emission in the segments belonging to the subset to render the segments belonging to the subset.
